(19) United States
(12) Patent Application Publication
(10) Pub. No.: US 2023/0084075 A1
(43) Pub. Date: Mar. 16, 2023

(54) USE OF A NICKEL-CHROMIUM-IRON ALLOY

(71) Applicant: VDM Metals International GmbH, Werdohl (DE)

(72) Inventors: Martin WOLF, Dortmund (DE); Helena ALVES, Dortmund (DE); Rainer BEHRENS, Iserlohn (DE)

(73) Assignee: VDM Metals International GmbH, Werdohl (DE)

(21) Appl. No.: 17/797,628

(22) PCT Filed: Mar. 22, 2021
(86) PCT No.: PCT/DE2021/100280

§ 371 Date: Aug. 4, 2022

(30) Foreign Application Priority Data
Apr. 6, 2020 (DE) 10 2020 109 510.4
Mar. 18, 2021 (DE) 10 2021 106 624.7

(51) Int. Cl. B23K 35/30; C22C 30/02; B23K 35/02

(52) U.S. Cl. CPC B23K 35/3033; C22C 30/02; B23K 35/0261

(57) ABSTRACT

Alloy with the composition (in wt. %) Ni 33.5-35.0%, Cr 26.0-28.0%, Mo 6.0-7.0%, Fe<33.5%, Mn 1.0-4.0%, Si<0.1%, Cu 0.5-1.5%, Al 0.01%-0.3%, C<0.01%, P<0.015%, S<0.01%, N 0.1-0.25%, B 0.001-0.004%, Se>0-1.0%, if required W<0.2%, Co<0.5%, Nb<0.2%, Ti<0.1%, and impurities from the melting process, is used as a welding-plating material in the area of thermal processing systems, in particular rubbish, biomass, sewage sludge and substitute fuel systems, wherein, after the build-up welding, in the operationally stressed state in a fully austenitic structural matrix, the welding-plating material forms a sigma phase and other hard particles in the weld material microstructure in a targeted manner.

The invention relates to the use of a nitrogen-alloyed nickel-chromium-iron alloy for a new application in the field of thermal recycling.

EP 2 632 628 A1 discloses a workable homogeneous austenitic nickel alloy having a high corrosion resistance against aggressive liquid media, both under oxidation and reducing conditions, and an excellent resistance against local corrosion in acid, chloride-containing media. The alloy consists of (in mass-%) chromium 26.0-28.0%, molybdenum 6.0-7.0%, iron max. 33.5%, manganese 1.0-4.0%, silicon max. 0.1%, boron 0.001-0.0040, copper 0.5-1.5%, aluminum 0.01-0.3%, magnesium 0.001 -0.15%, carbon max. 0.01%, nitrogen 0.1-0.25%, nickel 33.5-350, rare earths >0 to 1.0% and further smelting-related impurities. The alloy is suitable as a material for component parts that must be resistant to chemical attack.

As cladding materials for the build-up welding or the flame-spraying in the application for the thermal recycling, such as, for example, in refuse incineration systems, substitute material incineration systems or biomass systems, mostly nickel alloys are usually used at present, such as, for example, FM 625 (UNS N06625), FM 622 (UNS N06022) as well as FM 686 (UNS N06686).

Corrosion stresses in component parts and surfaces of thermal recycling systems contacted by flue gas are manifold and complex. Thus diverse diffusion-controlled high-temperature corrosion types occur, such as, for example, corrosion due to halogens containing chlorine and increasingly bromine, due to sulfidation, due to carburization, due to molten salts, or corrosion due to low-melting molten metals. Beyond this, the materials used are severely stressed additionally by wet-corrosion mechanisms during shutdown and maintenance periods in cases of dew-point undershoots or cleaning tasks. A further material stress occurs due to the thermal cycling load during startup and shutdown of the system or due to local and temporary “streaks of flame” in the incineration chamber.

Despite the corrosion protection of heat-exchanger tubes, heating surfaces as well as flue-gas-contacted surfaces and other component parts by cladding with these known materials, wasting away—depending on material used and operating conditions—takes place at the superheater tubes and other thermally stressed component parts, thus forcing the operator into shutdowns and cost-intensive maintenance work and possible necessary new construction.

The material described in EP 2 632 628 A1 has been used heretofore exclusively in the wet-corrosion area, in which electrochemical reactions in conjunction with electrolytes cause the corrosion attack. Known areas of application are: chemical processes involving phosphoric acid, sulfuric acid, seawater and brackish-water applications, or pickling systems using nitric acid/hydrofluoric acid.

A system for generation of energy from biomass has become known from DE 10 2007 062 810 A1. Parts of this system can consist of heat-resisting and corrosion-proof materials, preferably of stainless steel. Stainless steels with higher chromium and molybdenum contents are specified. The materials specified there are not suitable for build-up welding, however, since these relatively low-alloyed materials form residual delta ferrite to an increasing extent in the microstructure, especially in conjunction with the dilution by iron that takes place in the weld metal during build-up welding, thus greatly restricting the use in general both under wet and high-temperature corrosion conditions.

The objective of the invention is to provide the alloy that according to the prior art is permitted only for low temperatures up to max. 450° C. with a new field of application.

This objective is accomplished by the use of an alloy with the composition (in mass-%)

Ni 33.5-35.0%

Cr 26.0-28.0%

Mo 6.0-7.0%

Fe<33.5%

Mn 1.0-4.0%

Si≤0.1%

Cu 0.5-1.5%

Al 0.01%-0.3%

C≤0.01%

P≤0.015%

S≤0.01%

N 0.1-0.25%

B 0.001-0.004%

sE>0-1.0%

if necessary

W≤0.2%

Co≤0.5%

Nb≤0.2%

Ti≤0.1%,

as well as smelting related impurities,

as weld-cladding material in the field of thermal recycling systems, especially refuse, biomass, sewage sludge and substitute material incineration systems, wherein, after the build-up welding, the weld-cladding material selectively forms, in operationally-stressed condition, within a fully austenitic microstructure matrix, sigma phase and other hard particles in the weld-metal microstructure.

The formation of sigma phase causes a dispersion of hard particles in the weld-metal microstructure, which leads to an increase of hardness of the weld-metal microstructure, whereby an unexpectedly high resistance to the erosion-related depletion of protective top layers is achieved. Due to the formation of the sigma phase, a disproportional increase of the resistance of such a build-up weld is therefore achieved in thermal recycling systems in the operationally stressed condition. A further contribution against erosion or erosion-assisted corrosion is to be assumed due to the formation of chromium carbides at the application temperature. The weld metal therefore achieves an unusually high resistance against mechanical friction stress and thus also against erosion by particles and dust only in the operationally stressed condition, due to the precipitation of intermetallic phases such as the sigma phase.

It is also to be expected in the case of very long service times of more than 10,000 hours that, under the cyclic conditions of a thermal recycling system, where not only the purely diffusion-controlled/electrochemical corrosion plays a role, but in particular so also does the combination with the resistance of a material against mechanical stress, e.g. due to scattered and smoke particles (erosion and erosion-corrosion), this material acquires a novel properties profile.

In addition, the iron(II) chloride or iron(III) chloride formation that actually occurs in iron-containing materials, is strongly suppressed, with accompanying material dissolution, especially at low oxygen partial pressures.

In various laboratory investigations and welding activities under production conditions, it has been proved that this material acquires an excellent weldability—high safety against cracking and good wetting capacity—relative to the technique of weld cladding, both for the tungsten inert gas (TIG) welding technique and for the metal shield gas (MSG) welding technique. The application of weld-cladding layers may take place not only by build-up welding but also, for example, by flame or plasma spraying using powder or wire. Advantageously, the alloy is used together with the welding, flame spraying or plasma spraying techniques as cladding material in the field of systems for thermal recycling, such as, for example, refuse, biomass, sewage sludge, substitute material incineration systems.

In the wet corrosion test of ASTM G 48C, the critical pitting corrosion temperature for the parent metal in the delivery condition is typically higher than or equal to 85° C. The resistance to pitting corrosion is lowered by the formation of sigma phase, but nevertheless the alloy is so highly alloyed that the chromium contents present in the austenitic matrix ensure passivity.

Advantageous further developments of the subject matter of the invention can be inferred from the dependent claims.

The alloy is usable in particular for the coating of steels via the liquid phase, such as, for example, welding or flame spraying, which has a high corrosion resistance against aggressive media that may be formed during the thermal recycling.

Preferred chemical compositions (in mass-%) are listed in the following:

Ni 33.5-35.0%

Cr 26.0-28.0%

Mo 6.0-7.0%

Fe<33.5%

Mn 1.8-3.0%

Si≤0.1%

Cu 1.0-1.5%

Al 0.05%-0.3%

C≤0.01%

P≤0.015%

S≤0.01%

N 0.2-0.25%

B 0.001-0.004%

sE 0.020-0.060%

if necessary

W≤0.2%

Co≤0.5%

Nb≤0.1%

Ti≤0.5%,

as well as smelting related impurities.

During investigations of the above-mentioned material in the form of build-up welds on 16Mo3 tubes, it was surprisingly and unforeseeably found that this can also be used advantageously in the temperature range and under the specific conditions of thermal recycling.

In the following, the invention will be explained in more detail on the basis of an example:

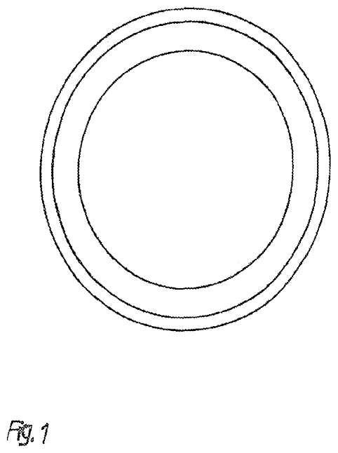

FIG. 1 shows a real heat-exchanger tube in cross section, which can typically be used as a steam-generator tube in a refuse incineration system. The inner tube consists of the 16Mo3 C-steel and has a material thickness of 5 mm and a diameter of 38 mm. By means of the metal active gas arc welding process (MSG), the build-up welding material FM 31 plus was applied with a layer thickness of 2.0-2.4 mm in a single layer under rotation of the C-steel tube and an adapted lateral movement of the welding torch, whereby an outer layer of build-up weld metal and a metallurgical bond between C-steel tube and weld metal were formed. The following welding parameters were used for production of the build-up weld: welding current (pulsed) with <I>=108 A, welding voltage U=26 V, overlap=50%. A four-component gas containing argon, helium, hydrogen and carbon dioxide was used as shield gas. The wire diameter of the FM 31 plus, from batch 118903, was 1.0 mm.

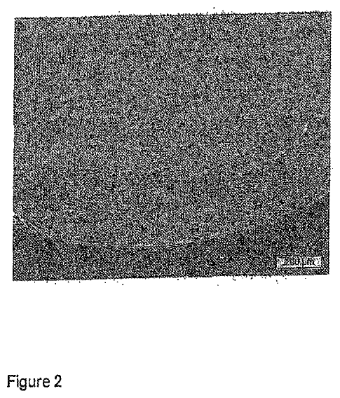

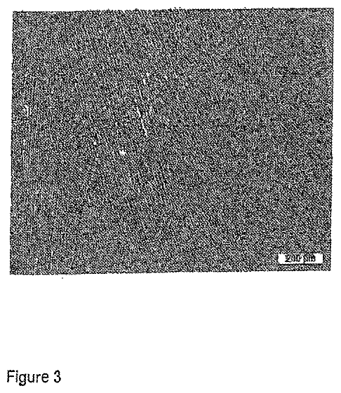

FIGS. 2 and 3 show metallographic microsections of this build-up weld, wherein FIG. 2 shows the transition from C-steel into the FM 31 plus weld metal and FIG. 3 shows the pure, finely dendritically solidified, fully austenitic weld metal of FM 31 plus.

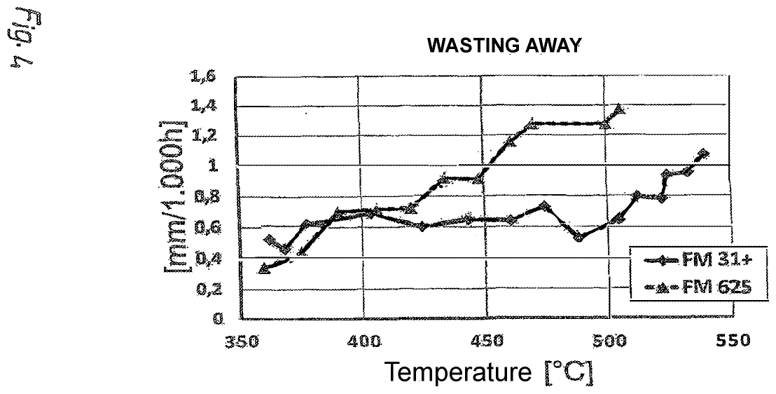

FIG. 4 shows a comparison of the measured wasting away after an aging test of weld-clad heat-exchanger tubes, welded with FM 625 and FM 31 plus, after 1000 hours under real boiler room conditions of a refuse incineration system with maintenance of a defined temperature gradient between 360° C. and 540° C. steam temperature at the inner wall of the tube over the entire aging time. The temperature load relevant for cladding at the outside of the tube is much higher and lies mainly above 450° C. In the performed investigations, it was unexpectedly found that the build-up welding from FM 31 plus is basically as good as the build-up welding from FM 625 as regards the observed wasting away, and over a broad temperature range is even much better, even though the iron content, which otherwise under chlorinating conditions is particularly harmful, is higher by at least 28.5 mass-% in FM 31 plus than in FM 625.

In Table 1, the compositions are listed on the one hand for the build-up weld material according to the invention as well as for alternative materials used heretofore.

TABLE 1

| Werkstoff | FM 31plus | FM 625 | FM 622 |
|---|---|---|---|
| Chg. Nr. | 118903*) | 115949 | 122001 |
| C | 0.003 | 0.015 | 0.005 |
| S | 0.002 | 0.002 | 0.004 |
| N | 0.22 | 0.018 | 0.016 |
| Cr | 26.6 | 22.3 | 21.4 |
| Ni | 34.0 | 64.3 (Rest) | 59.2 (Rest) |
| Mn | 1.94 | 0.01 | 0.16 |
| Cu | 1.24 | 0.01 | 0.01 |
| Si | 0.02 | 0.07 | 0.03 |
| Mo | 6.47 | 9.21 | 13.7 |
| Fe | 29.13 | 0.20 | 2.2 |
| Al | 0.07 | 0.06 | 0.11 |
| B | 0.0024 | <0.001 | 0.001 |
| V | 0.03 | <0.01 | 0.17 |
| W | 0.10 | 0.02 | 2.87 |
| sE | 0.04 | | |

*)Smelting related impurities: Co, P, Nb, Ti
Werkstoff = Material;
Chg. Nr. = Batch no.;
Rest = the rest
Commas should be read as periods [.]

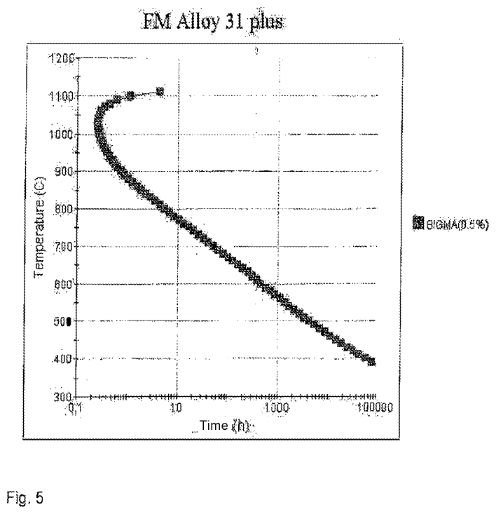

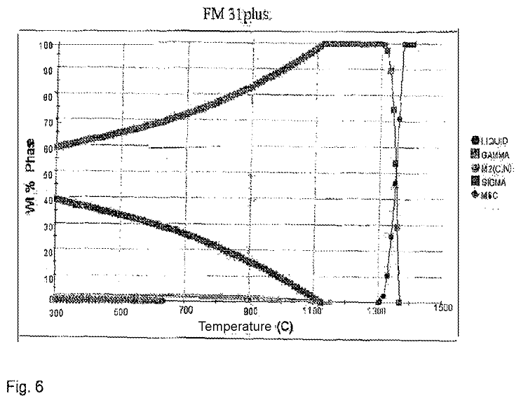

The material FM 31 plus as a weld-cladding material for component parts in thermal recycling systems is distinguished from the comparison materials by the autogenous development of property-improving microstructure phases in the range of the operating temperatures. Calculations with the J-MatPro software for Calphad in FIG. 5 and FIG. 6 describe that this effect is caused among other factors by the formation of intermetallic phases, such as, for example, the sigma phase. This can also be proved by metallographic investigations.

1. Use of an alloy with the composition (in mass-%)
Ni 33.5-35.0%
Cr 26.0-28.0%
Mo 6.0-7.0%
Fe<33.5%
Mn 1.0-4.0%
Si≤0.1%
Cu 0.5-1.5%
Al 0.01%-0.3%
C≤0.01%
P≤0.015%
S≤0.01%
N 0.1-0.25%
B 0.001-0.004%
sE>0-1.0%
if necessary
W≤0.2%
Co≤0.5%
Nb≤0.2%
Ti≤0.1%,
as well as smelting related impurities,
as weld-cladding material in the field of thermal recycling systems, especially refuse, biomass, sewage sludge and substitute material incineration systems, wherein, after the build-up welding, the weld-cladding material selectively forms, in operationally-stressed condition, within a fully austenitic microstructure matrix, sigma phase and other hard particles in the weld-metal microstructure.

2. Use according to claim 1 with the following composition (in mass-%):
Ni 33.5-35.0%
Cr 26.0-28.0%
Mo 6.0-7.0%
Fe<33.5%
Mn 1.8-3.0%
Si≤0.1%
Cu 1.0-1.5%
Al 0.05%-0.3%
C≤0.01%
P≤0.015%
S≤0.01%
N 0.2-0.25%
B 0.001-0.004%
sE 0.020-0.060%
if necessary
W≤0.2%
Co≤0.5%
Nb≤0.1%
Ti≤0.5%,
as well as smelting related impurities.

3. Use according to claim 1, wherein the weld-cladding material is used in the field of heat exchanger tubes of refuse incineration systems.

4. Use according to claim 1, wherein the chromium content in the alloy, being at least 26%, is so high that chlorine or chlorine compounds from the flue-gas atmosphere lead to an only slight corrosion of the protective layer.

5. Use according to claim 1, wherein, due to the nickel content of at least 33.5% in the weld metal, the weld cladding material remains fully austenitic and no delta ferrite forms in corrosion-impairing proportions, even in the case of welding-related dilution with iron.

6. Use according to claim 1, wherein the weld cladding material is used for repairs.

7. Use according to claim 1, wherein the weld cladding material exists in the form of a wire.

8. Use according to claim 1, wherein the weld cladding material exists in the form of welding strips for submerged arc welding or electroslag welding.

9. Use according to claim 1, wherein the weld cladding material exists in the powder form.
